(19) United States
(12) Patent Application Publication
(10) Pub. No.: US 2019/0081952 A1
(43) Pub. Date: Mar. 14, 2019

(54) System and Method for Blocking of DNS Tunnels

(71) Applicant: Michael C. Wood, Wilton Manors, FL (US)

(72) Inventor: Michael C. Wood, Wilton Manors, FL (US)

(21) Appl. No.: 16/189,763

(22) Filed: Nov. 13, 2018

Related U.S. Application Data
(63) Continuation-in-part of application No. 15/429,073, filed on Feb. 9, 2017.
(60) Provisional application No. 62/295,315, filed on Feb. 15, 2016.
(60) Provisional application No. 62/314,225, filed on Mar. 28, 2016.
(60) Provisional application No. 62/328,912, filed on Apr. 28, 2016.
(60) Provisional application No. 62/348,518, filed on Jun. 10, 2016.
(60) Provisional application No. 62/350,556, filed on Jun. 15, 2016.
(60) Provisional application No. 62/354,588, filed on Jun. 24, 2016.
(60) Provisional application No. 62/395,021, filed on Sep. 15, 2016.
(60) Provisional application No. 62/439,778, filed on Dec. 28, 2016.
(60) Provisional application No. 62/587,975, filed on Nov. 17, 2017.

(51) Int. Cl. H04L 29/06; H04L 29/12

(52) U.S. Cl. CPC H04L 63/101; H04L 63/1491; H04L 63/168; H04L 61/1511; H04L 63/145

(57) ABSTRACT

Systems and methods for allowing and blocking data packets sent to and from browser software applications and non-browser software applications operated on a computing device are described. The system includes a computing device having a processor and an associated memory, wherein the computing device is communicatively connected to a communications network. The system further includes a browser software application, a non-browser software application, or both being operable on the computing device. The system also includes a whitelist. The system includes processes for intercepting at least one DNS query resulting from at least one attempt by the browser software application to connect to at least one domain and for blocking the at least one DNS query, wherein the at least one DNS query is for a domain name that is not permitted by the whitelist. The system may further implement both network address translator (NAT) and DNS sinkhole processes.

### CROSS REFERENCE TO RELATED APPLICATIONS

This application is a nonprovisional application of and claims priority from U.S. Provisional patent application Ser. No. 62/587,975 filed on Nov. 17, 2017, and is a continuation-in-part nonprovisional application of and claims priority from U.S. nonprovisional patent application Ser. No. 15/429,073 file on Feb. 9, 2017, which is a nonprovisional application of: U.S. provisional patent application Ser. No. 62/295,315 filed on Feb. 15, 2016; U.S. provisional patent application Ser. No. 62/314,255 filed on Mar. 28, 2016; U.S. provisional patent application Ser. No. 62/328,912 filed on Apr. 28, 2016; U.S. provisional patent application Ser. No. 62/348,518 filed on Jun. 10, 2016; U.S. provisional patent application Ser. No. 62/350,556 filed on Jun. 15, 2016; and U.S. provisional patent application Ser. No. 62/354,588 filed on Jun. 24, 2016; U.S. provisional patent application Ser. No. 62/395,021 filed on Sep. 15, 2016; U.S. provisional patent application Ser. No. 62/439,778 filed on Dec. 28, 2016. The foregoing applications and U.S. Pat. No. 9,467,324 are incorporated in their entirety herein by reference.

### FIELD OF THE INVENTION

The invention relates to systems and methods for blocking malware. More particularly, the invention relates to systems and methods for blocking DNS tunnels used by hackers.

### BACKGROUND

According to the “2016 Verizon Data Breach Investigations Report,” the most prevalent form of hacking in 2016 was persistent malware installed via phishing. Such Trojans secretly connect infected computing devices to hackers' command and control centers. These Trojans use a systematic method to evade detection so that they can remain persistently undetected. The Trojans wait for a reputable application (“app”) to access the Internet, and then inject a copy of their code into the reputable app. Since firewalls and antivirus software only see the reputable app, they allow the injected code unfettered access to the Internet (and thereby, unfettered access to the hacker's command and control center).

Persistent malware has been a longstanding problem for the cybersecurity industry. The industry's failure to find adequate solutions is highlighted by how popular this longstanding hacking method has become.

Browser software applications and non-browser software applications often request Internet access via domain names (such as, for example, apple.com, microsoft.com, and adobe.com). When an app asks the Operating System for access to a domain name, the Operating System must convert the domain name into an IP Address (since all Internet communication uses IP Addresses). To convert the domain name into an IP Address, the Operating System sends a query to a Domain Name Server (called a DNS Server). DNS Servers maintain records of which IP Addresses belong to which domain names.

For example, consider the case when an app tells the Operating System that it wants to talk to apple.com. The Operating System sends the domain (apple.com) to the DNS Server. The DNS Server replies with the IP Address(es) of the domain. Now, the Operating System knows how to provide apps direct communication to apple.com's server.

Hackers have developed a systematic way to use this DNS communication to their advantage. Hackers have developed a technique called “DNS Tunneling” to freely transmit a computer's digital contents to hacker control centers. As reported by Steve Jaworski of the SANS Institute on May 31, 2016 in an article titled “Using Splunk to Detect DNS Tunneling”:

“Data that can be leaked using a DNS tunnel could be intellectual property, trade secrets, customer records and employee data. A DNS tunnel requires software on the victim machine to work. The malicious actor is able to bypass all of the organization's security controls and successfully establish a persistent backdoor with a DNS tunnel.”

DNS Tunneling is a very severe threat given that it can be used to secretly leak data of all kinds to hackers. More troubling still, DNS tunneling is a very popular hacking technique due to its combination of stealth and strength. In fact, 40% of enterprise networks showed evidence of DNS tunneling in a recent security assessment by Infoblox:

“SANTA CLARA, Calif., Aug. 31, 2016 (GLOBE NEWSWIRE)—Infoblox Inc. (NYSE:BLOX), the network control company, today announced results of the Infoblox Security Assessment Report for the second quarter of 2016, which finds that 40 percent—nearly half—of files tested by Infoblox show evidence of DNS tunneling, a significant security threat that can indicate active malware or ongoing data exfiltration within an organization's network.”

DNS Tunneling has been a persistent problem for over eighteen years because those skilled in the art have been unable to find a definitive solution to the problem. In fact, the May 31, 2016 study by Steve Jaworski casually stated the view of prominent data communication experts: “Preventing all DNS tunneling is not possible . . . . ”

Those skilled in the art are literally taught against the possibility of empirically preventing all DNS tunneling.

The reason for such teaching is due to an erroneous assumption: the only way to keep DNS both open and secure is through statistical analysis. One approach to prevent DNS tunneling is to close access to non-whitelisted sites. While this prevents DNS tunneling, the closure of access to non-whitelisted sites is highly impractical. In the vast majority of environments, an open DNS system is necessary. After all, the DNS translation of domains into IP addresses is the very heart of modern Internet communication. Thus, DNS access needs to remain open.

But in open DNS environments, the assumption is that DNS tunneling can only be detected through statistical analysis. Statistical analysis can only be applied after a certain amount of data has already been leaked, hence the long-held assumption that “preventing all DNS tunneling is not possible . . . . ”

### How DNS Tunneling Works

The following paragraphs examine how DNS tunneling works. Whenever a user enters in a domain name (e.g., “apple.com”), the user's computer asks a DNS server for the domain's IP address. The user's computer then uses the returned IP address to communicate with the domain (e.g., view the webpage at apple.com).

Domain owners often host multiple subdomains. For example, Apple hosts the following subdomains: images.apple.com and metrics.apple.com. Such subdomains can have different IP addresses than the main domain. For example, images.apple.com can have a different IP address than apple.com. For this reason, a separate DNS query is required for each subdomain (if the IP addresses of the subdomains were not already conveyed in any previous DNS query).

If a DNS server does not know the IP address of a subdomain, then it queries the IP address from the domain's Name Server. For example, if the DNS server does not know the IP address for images.apple.com, then it will ask apple.com's Name Server for the IP address. DNS Tunneling uses this particular behavior to the hacker's advantage.

For example, let's say that a hacker owns the following domain: iamahacker.com. Let's further say that the hacker wants to gather social security numbers. Let's further say that the hacker's malware is running on John Smith's computer, and it has used key logging to discover that John Smith's social security number is 123-45-6789. This malware can use DNS Tunneling to secretly send this information to the hacker.

The malware could tell the operating system that it wants to access JohnSmith-123456789.iamahacker.com. This will cause the operating system to send the following request to the DNS server: what is the IP address of JohnSmith-123456789.iamahacker.com? The DNS Server will not have this IP address in its cache. Therefore, the DNS Server asks iamahacker.com's Name Server: what is the IP address of JohnSmith-123456789.iamahacker.com? Now, the hacker's name server has both John Smith's name and his social security number.

Naturally, the malware typically encrypts the information when constructing the subdomain name, and the hacker's name server decrypts it to extract the information. However, the method is identical to that above. The encryption simply conceals what information is being tunneled out (i.e., transferred to the hacker).

Hackers use DNS tunnels to send any information they want: birth dates, credit card numbers, bank account numbers and passwords, Word documents, Excel spreadsheets, keystrokes, and even screenshots.

Even more disturbing, hackers can use the replies to set up a bidirectional command and control server. A very simple scheme would be to use the final number of the returned IP address. For example:
IP address ends in 001: Start Sending Keystrokes
IP address ends in 002: Stop Sending Keystrokes and Remove Self

For example, the hacker's name server could send an IP address that ends in 001. The malware reads the IP address and starts sending keystrokes once every five minutes. Each transmission requires generating another subdomain. The DNS query for each new subdomain could produce a response that includes an IP address that ends in 001 (causing the malware to continue its keystroke sending campaign). Eventually, the hacker receives the keystrokes being sought (e.g., email username and password). In this example, the hacker now sends an IP address ending in 002. The malware stops its keystroke gathering campaign and erases itself from the computer. The malware is now undetectable (since it no longer exists), and the hacker has the information he was seeking.

DNS servers can also host text records associated with each domain and subdomain. These text records can be used to send much more sophisticated commands to malware resident on a user's computer. For example, malware can tell the operating system that it needs a specific TXT record for iamahacker.com. The returned record could contain very specific instructions, or even provide executable assembler code to expand the malware's capabilities on the fly.

Bottom line: DNS tunneling is a very flexible system that hackers can exploit in any manner their creativity allows. DNS tunneling must be shut down for true security to be achieved.

In summary, by piggybacking on the standard behavior of the DNS system, hackers can create robust anonymous communication with their control centers. Since DNS is the very heartbeat of the Internet, any solution for resolving this problem must allow legitimate DNS queries to flow freely. Otherwise, Internet access could be severely interrupted.

### State of the Art

The cybersecurity industry has largely approached the problem of DNS Tunneling through statistical analysis. The objective of statistical analysis is to reduce the occurrence of DNS Tunneling, but such a method does not eliminate DNS Tunneling altogether. For example, one statistical measure is to look for multiple oddly-named subdomains from the same domain. A fairly large number of samples are needed to ferret out bad actors from good ones. In other words, a fairly large amount of data has been sent to the hacker before the statistical analysis can (possibly) detect the tunnel (if it detects the tunnel at all).

Another approach has included DNS Sinkholes. Blacklist-oriented Sinkholes return fake IP addresses for known malicious sites; whitelist-oriented Sinkholes return fake IP addresses for any domain not included in the static whitelist.

DNS Sinkholes have the same blacklist/whitelist issues discussed in prior filings. Most notably that blacklists are always out of date, and static whitelists are too restrictive (often not including necessary, legitimate domains—thereby preventing necessary, legitimate communication).

Thus, there remains a deeply felt, longstanding need to prevent even a single fake DNS query while simultaneously allowing all legitimate traffic to freely flow.

### Dynamically-Generated Whitelisting

Two general categories of processes exist that ask the Operating System to resolve domain names: browser apps, and non-browser apps. This disclosure describes novel systems and methods of dynamically-generated whitelisting for both types of processes:
For Browsers: Only allow traffic to currently open webpages and the sites that they pull content from.
For Non-Browsers: Only allow traffic to domains owned by the maker of the app.

For example, when a Firefox browser app user accesses Samsung.com, then Firefox is solely allowed to access Samsung.com and all the sites from which this webpage pulls content. All other domains remain blocked.

As a non-browser example: when Microsoft Word is being used, Microsoft Word is only allowed to talk to domains owned by Microsoft (since Microsoft is the maker of the app).

In order to accomplish the above, the security system must:
Keep an ongoing record of the domains belonging to currently open webpages, and the domains of the sites from which these webpages pull content.
Keep an ongoing record of the makers of all currently running apps.

This results in the following two categories of records:
Domain Records: Such as those created on the fly from dynamically-generated browser whitelists.
Owner Records: Such as those obtained either from dynamically-generated whitelist from non-browser apps and/or provided by a system administrator, third-party, and/or the user.

Just as dynamically generated whitelisting overcomes the impractically of static whitelists for direct network access; so too dynamically generated whitelisting overcomes the impracticalities of static DNS whitelisting (with one notable exception below). In other words, the system and method for stopping DNS tunnels is: Only allow domain-to-IP resolution for DNS queries with domains matching either a Domain Record entry and/or an Owner Record entry.

For example, in security systems containing either or both of the above records, DNS tunnels can be eliminated by the following process:
Extract the domain from each DNS query.
If the domain is in the Domain Records list, then allow the query to proceed.
Otherwise, obtain the owner of the domain.
If the owner of the domain matches an entry in the Owner Records, then allow the query proceed.
Otherwise, discard the query.

There are three ways in which the Domain and Owner Records can be created:

Automatically: The security system can automatically generate domain records for browsers by automatically adding the webpage domain of the browser tab and all the domains accessed by that tab (i.e., the sites from which the webpage pulls content). The security system can automatically generate owner records by retrieving the owner info of each process running on the machine.

Statically: Some domain and/or owner entries can be statically provided. For example, for browsers, the domains belonging to digital certificate authorities can be statically provided since https relies on access to such domains; for non-browsers, the owner of the operating system (e.g., Microsoft Corp. or Apple Inc.) and the owner of various hardware components (e.g., Intel Corp. and Dell Inc.) can be statically provided so that the Operating System and associated hardware can automatically update themselves.

Interactively: The user can be presented in real-time or near-real-time the domains and/or owners to which the computer wants to communicate, and the user can interactively choose who to allow and who to block.

Both automatically-generated whitelists and interactively-generated whitelists constitute “dynamically-generated whitelists,” whether used separately, concurrently, and/or combined.

In environments where records are solely created automatically and/or statically, some embodiments can implement the above system and method without disrupting any running programs (depending on the internal architecture of the browser or app). However, when records are created interactively (or depending on the internal architecture of the browser or app), it is possible for some applications or the browser itself to break when the above process is employed.

For example, let's say that the browser wants to access ‘apple.com’. Let's further say that the user needs to interactively allow access to apple.com after being informed that his computer wants to access apple.com. By the time the user communicates his allowance, the app will have already expected a DNS reply telling the IP address of apple.com. But since the DNS request was blocked (awaiting the user's decision), there will not be any timely reply in the above approach. This can cause many apps to generate internal errors, making the approach infeasible in such environments.

A great need exists to finally be able to expose and block persistent malware. A further need exists to be able to detect and block Internet traffic to and from Trojans with which a computing device is infected while ensuring that the legitimate traffic to and from the infected apps is allowed. Another needs exists for systems, devices, and methods to prevent even a single fake DNS query while simultaneously allowing all legitimate traffic to freely flow.

### SUMMARY

The invention relates to systems and methods for detecting and blocking data packets sent to and from browser software applications and/or non-browser software applications installed or operable on a computing device and infected with Trojans and/or other malware that attempt to communicate with one or more hacker's command and control centers. In exemplary embodiments, the system is capable of allowing and blocking data packets sent to and from both browser software applications and non-browser software applications installed or operable on a computing device. In other embodiments, systems that allow and block traffic to and from only browser software applications or to and from only non-browser software applications may be used, although for providing the most effective computer security, systems that perform both methods are used. The allowance and blocking of data packets to and from various sources may be performed automatically by the system or may be accomplished by action taken by a user of the computing device.

The systems and methods described herein can use dynamically-generated whitelisting based on the maker of a non-browser software application being a trusted source of data packets sent to the non-browser application or based on consensus by one or more consensus trusted computing devices that connections made by an URL open in a browser software application are correct and trusted. The system uses a local firewall of the computing device to block data packets to and from web addresses (i.e., domains, subdomains, path names, or URLs) that are not owned by the makers of the application, that are not trusted by the consensus trusted computing devices, or that are blocked by affirmative selection for blocking by a user of the computing device. The system can also include a health monitor engine to ensure that a kernel drive of the system is operational and not disabled by malware, which would prevent the system from detecting and blocking traffic between the browser and non-browser software applications installed on a computing device and a hacker's command and control center.

A Trojan can anonymously communicate with hacker control centers in three ways:

(1) Secretly use a browser software application such as, for example, Firefox, Chrome, or Internet Explorer;

(2) Secretly use a non-browser software application such as, for example, Microsoft Word or Adobe Reader; and/or

(3) Secretly use an operating system's conversion of domain names to IP addresses.

The systems, devices, and methods described herein are useful for stopping the final method above used by Trojan Internet communication. Through these systems, devices, and methods, all three methods of anonymous Internet communication, commonly used by hackers, are finally disabled.

This disclosure overcomes this long-held assumption by those skilled in the art that preventing all DNS tunneling is not possible. In fact, this disclosure unveils systems and methods for blocking DNS tunnels before even one single byte is sent to a hacker's command and control center, thereby solving a longstanding need in a manner that those skilled in the art are taught against.

Accordingly, the invention features a system for blocking DNS tunnels. The system includes a computing device having a processor and an associated memory, wherein the computing device is communicatively connected to a communications network; a browser software application being operable on the computing device; a dynamically-generated whitelist; a process for intercepting at least one DNS query resulting from at least one attempt by the browser software application to connect to at least one domain; and a process for blocking the at least one DNS query, wherein the at least one DNS query is for a domain name that is not permitted by the whitelist.

In another aspect, the invention can feature the software application being or including a browser software application.

In another aspect, the invention can feature the software application being or including a non-browser software application.

The invention also features a system for blocking DNS tunnels, wherein the system includes: a computing device having a processor and an associated memory, wherein the computing device is communicatively connected to a communications network; a browser software application being operable on the computing device; a process for intercepting at least one DNS query resulting from at least one attempt by the browser software application to connect to at least one domain; a process for returning a fake IP address in response to the at least one DNS query; a process for intercepting at least one data communication packet; a process to identify whether a remote IP address is a previous fake IP address previously provided by the system in response to a previous DNS query; a process for finding the actual remote IP address for the at least one data communication packet destined for the fake IP address; and a process for replacing the fake IP address with the actual IP address in the at least one data communication packet.

In another aspect, the invention can feature the software application being or including a browser software application.

In another aspect, the invention can feature the software application being or including a non-browser software application.

The invention also provides a method for blocking DNS tunnels, which includes the steps of: (a) providing a system that includes: (i) a computing device having a processor and an associated memory, wherein the computing device is communicatively connected to a communications network; (ii) a software application being operable on the computing device; and (iii) a dynamically-generated whitelist; (b) intercepting at least one DNS query resulting from at least one attempt by the software application to connect to at least one domain; and (c) blocking the at least one DNS query, wherein the at least one DNS query is for a domain name that is not permitted by the whitelist.

Another method of the invention can feature the software application being or including a browser software application.

Another method of the invention can feature the software application being or including a non-browser software application.

The invention also provides another method for blocking DNS tunnels, which includes the steps of: (a) providing a system that includes: (i) a computing device having a processor and an associated memory, wherein the computing device is communicatively connected to a communications network; and (ii) a software application being operable on the computing device; (b) intercepting at least one DNS query resulting from at least one attempt by the software application to connect to at least one domain; (c) returning a fake IP address in response to the at least one DNS query; (d) intercepting at least one data communication packet; (e) identifying whether a remote IP address is a previous fake IP address previously provided by the system in response to a previous DNS query; (f) finding the actual remote IP address for the at least one data communication packet destined for the fake IP address; and (g) replacing the fake IP address with the actual IP address in the at least one data communication packet.

Another method of the invention can feature the software application being or including a browser software application.

Another method of the invention can feature the software application being or including a non-browser software application.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a flow chart showing a process of the system for processing data packets.

FIG. 2 is a flow chart showing one embodiment of a system for processing data packets sent and received by a browser app.

FIG. 3 is a flow chart showing one embodiment of a system for processing data packets sent and received by a non-browser app.

FIG. 4 is a flow chart showing another embodiment of a system for processing data packets data packets sent and received by a browser app.

FIG. 5 is a flow chart showing still another embodiment of a system for processing data packets data packets sent and received by a browser app.

FIG. 6 is a flow chart showing another embodiment of a system for processing data packets data packets sent and received by a non-browser app.

FIG. 7 is a flow chart showing still another embodiment of a system for processing data packets data packets sent and received by a non-browser app.

FIG. 8 is a graphic representation of the principles that allow the system to operate effectively.

FIG. 9 is a schematic diagram of one embodiment of the system.

FIG. 10 is a schematic diagram of another embodiment of a system for blocking domain name server (DNS) tunnels used by Trojan malware based on a whitelist.

FIG. 11 is a schematic diagram of one embodiment of a system for blocking DNS tunnels used by Trojan malware, wherein a local device (such as a router) houses both a network address translator (NAT) and DNS sinkhole processes.

FIG. 12 is a schematic diagram of another embodiment of a system for blocking DNS tunnels used by Trojan malware, wherein the system uses both NAT and DNS sinkhole processes.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a novel system and method that both exposes and blocks persistent malware—finally providing genuinely effective protection against this now most prevalent form of hacking. Trojans are but one example of persistent malware that communicates with a hacker's command and control center; other types of persistent malware exist as will be understood by one of skill in the field. As used herein, the terms “computer” and “computing device” mean a computer, a tablet computer, a server, a mobile device (e.g., a cellular telephone, smartphone, etc.), a gaming device, a smart appliance, a smart television, a smart light bulb, a smart outlet adapter, a smart automobile, and any other device that includes a processor and is communicatively connected to a communications network. The computing device may also be a router or a device that contains, includes, or is communicatively connected to a router. The term “smart” used with several items in the foregoing list means that such items are electronic devices that have a wireless connection to a communications network. For purposes of convenience, the term “computing device” is used most frequently herein. In most but not all instances, the computing device also includes at least one browser software application, at least one non-browser software application, or both. Such software applications can be installed locally on the computing device or can be installed on a remote computing device but operated on the local computing device.

The term “web address” used herein means a URL name, a path name of a URL, a domain name of a URL, or a subdomain of a URL. The terms “identity” and “name,” when used alone herein, mean an owner name, a URL name, a path name of a URL, a domain name of a URL, a subdomain of a URL, a derivative of one of the foregoing, or an alias representing one of the foregoing.

The term “app” used herein means a software application, which is installed on or operable on a computing device. The app may be a browser software application or a non-browser software application.

The term “domain” used herein means a domain name.

The invention features a system for detecting and blocking Trojans and other persistent malware that connect to one or more hackers' command and control centers. The system includes a browser software application installed on a computing device that is communicatively connected to a communications network, a process to communicate an identity or identities of one or more web addresses open in the browser software application, a process that catalogues the connections made by open web addresses, a firewall that intercepts packets to or from a browser and blocks packets that do not belong to an open web address or to any of the connections made by an open web address.

The system can feature automatically blocking a packet if it is to or from a browser yet does not belong to a subdomain of an open web address nor any of the connections made by an open web address. One or more trusted computing devices can record the correct connections made by web addresses so that the connections can be verified before being trusted.

The system can include a process that uses a statistical analysis to deduce the correct connections made by web addresses so that the connections can be verified before being trusted. The system can also include an interface, which displays the names of open web addresses to the user in a manner that permits the user to allow or block the web address. Such names can be the owner of the domain, a domain name, subdomain name, and/or a derivative of these and/or an alias representing any of these. When the user blocks a web address then all of its connections are blocked (unless such a connection is made by a separate, currently allowed web address).

The interface can display the connections opened by web addresses. The interface can display the connections opened by web addresses in a manner that permits the user to allow or deny such connections. The user may elect to allow only data packets that belong to user-opened web addresses or connections made by user-opened web addresses that the user has not denied.

The system can also include a reputation engine that can be used to initially allow or deny a web address (and its subsequent connections), such that web addresses that do not meet an established reputation threshold are initially blocked rather than initially allowed. In another embodiment, the reputation engine can be used to initially allow or deny a web address (and its subsequent connections), such that domains and/or subdomains that do not meet an established reputation threshold are initially blocked rather than initially allowed.

The aforementioned interface (or a different interface of the system) can display the names of automatically blocked packets. Such names can be a name of the owner of the domain, a domain name, subdomain name, and/or a derivative of these and/or an alias representing any of these. In another embodiment, the interface can display the names of automatically blocked packets in a manner that permits the user to override the blocked name. As with the prior embodiment, such names can be the owner of the domain, a domain name, subdomain name, and/or a derivative of these and/or an alias representing any of these.

In another embodiment, the system can feature a whitelist that can override the automatic blocking of browser-based packets that neither belong to an open web address nor to any of the connections made by open web addresses.

The reputation engine of the system may also be capable of overriding the automatic blocking of browser-based packets that neither belong to an open web address nor to any of the connections made by open web addresses if the reputation meets or exceeds an established threshold.

The system may display and allow the names of user-opened web addresses while not displaying, yet allowing, data packets belonging to connections made by user-opened web addresses. In this embodiment, the system may display and block the names of packets that do not meet the prior two conditions.

In another embodiment, the system may display and allow the names of user-opened web addresses while not displaying, yet allowing, data packets belonging to connections made by user-opened web addresses. The names of web addresses sending and receiving data packets that do not meet the prior two conditions may be displayed and blocked unless such packets are whitelisted in which case they are displayed and allowed.

The system can also feature an automated health monitor engine that periodically checks the status of the kernel driver to ensure that the kernel driver is operational. The automated health monitor engine can generate an alert if the kernel driver is disabled. The alert can be visual, audible, or both. In an exemplary embodiment, the automated health monitor engine can include an interface with a constantly changing visual display representing the health monitor checking of the kernel driver such that the display will cease constantly changing if the user interface is prevented from performing the kernel driver health monitoring, thereby alerting the user that the system and computing device have potentially been hacked.

The system can include a browser plugin, man-in-the-middle http/https interception (local and/or remote), and/or a web proxy for determining the identity of open web addresses and of connections made by open web addresses.

The invention also features a system for detecting and blocking Trojans and other malware that communicate with one or more hackers' command and control centers. The system includes a browser software application installed on a computing device that is communicatively connected to a communications network and a remote web proxy, which replaces the connections made by web addresses with aliases based on the domain of the web proxy or some other agreed upon domain. The system also includes a local firewall that blocks all browser-based packets not destined to or received from the web proxy. The web proxy can report the open web address to the firewall, and a firewall interface can display the open web addresses.

The firewall interface can permit the user to allow or deny the web addresses. The local firewall communicates denied web addresses to the web proxy, and the web proxy subsequently blocks the affected web addresses and their connections.

The system may initially block data packets that are not destined to or received from the web proxy except whitelisted subdomains, domains, domain owners, and/or IP addresses (which are allowed).

In one example, a web proxy could be used for browser traffic in which the web proxy communicates the web addresses of one or more open web addresses to the firewall of the system, and the web proxy could replace the connections made by the open web addresses with aliases such that the firewall could automatically block data packets if they do not belong to the subdomain and/or domain of any open web address.

The invention also features a system for detecting and blocking Trojans and other malware that connect to one or more hackers' command and control centers, wherein the system includes a non-browser software application installed on a computing device that is communicatively connected to a communications network, a process that communicates the owner of the domains of the data packets sent to or from the non-browser app, a process to communicate the maker of the non-browser app, and a process that initially blocks packets when the identity of the maker of the app does not match the identity of the owner of the data packet's domain.

This system can include a reputation engine in which packets are only initially blocked if the maker of the app does not match the owner of the domain, or if the reputation of the domain and/or the domain owner does not meet or exceed an established reputation threshold.

This system can also feature an interface that displays the app names and/or the names of apps' makers, and the owner of the remote domains with which each app attempts to communicate. The system can also include an interface (which may the same interface as the previously described one or a different interface) that permits the user to selectively allow or deny traffic to and from each app on a per domain and/or per domain owner basis.

The system can include a process that initially blocks all app/domain communication pairs, i.e., non-browser software applications and remote host addresses (also referred to herein as “destinations”) that communicate or attempt to communicate with one another. An interface of the system can display the app names and/or the names of their makers, and the owner of the remote domains with which they attempt to communicate. The system may include a second interface that permits the user to selectively allow traffic to and from each app on a per domain and/or per domain owner basis, or these steps may be completed using the first interface.

The system can further include a process that initially blocks all app/domain communication pairs for a temporary period of time and an interface that displays the app names and/or the names of their makers, and the owner of the remote domains with which they attempt to communicate. Either that first interface or a second interface may be provided by the system to permit the user to selectively quarantine the app/domain pairs before the time expires for the temporary period of time (in which case, the app/domain pair is allowed if not quarantined before the time expires).

The system may automatically allow legitimate DNS packets, traffic to digital certificate authorities, and legitimate local packets.

As previously detailed in prior disclosures, a user can control who can access the user's computing device when the user views the names of every party who wants to talk, in near real-time, each time the named entity wants to talk (i.e., communicate), whether that named entity is currently allowed or not. Entities can be any of the following (or derivatives or aliases of the following):

IP addresses

Subdomains (e.g., a.2mdn.net, b.2mdn.net, y.gstatic.com, and z.gstatic.com)

Domains, also referred to herein as Domain Names (e.g., 2mdn.net, and gstatic.net)

Registered Owners (e.g., “Google Inc.”)

We shall refer to the following as “Entity Hierarchy”: IP Addresses→Subdomains→Domains→Registered Owners. Each level of the Entity Hierarchy moving from left to right encompasses more data packets. A single Registered Owner name can encompass hundreds of Domains, thousands of Subdomains, and even tens of thousands IP Addresses. Thus, when displaying the identity of the entity who wants to communicate with the computing device, some embodiments may choose to use Domain Names and/or Registered Owner names to reduce the amount of information a user will need to see in order to make an informed choice over who can access the computing device and who cannot.

Two broad categories of PC Internet traffic exist: browser data packets sent to or from a browser software application and non-browser data packets sent to or from non-browser software applications. For non-browser traffic, the user may find it useful to choose the app/destination pair. For example, a user may want to allow WinWord to talk to Registered Owner Microsoft Corp.; yet the same user might want to block WinWord from talking to Registered Owner Richard Smith.

Allowing the user to allow or block an app/destination pair provides genuinely effective protection against the real-world problem of Trojans (also known as Trojan horse malware) injecting themselves into legitimate apps. For example, Richard Smith is the owner of xyz.org. If a Trojan injects itself into WinWord and tries to send sensitive data to trojan.xyz.org, one embodiment could show the user that WinWord wants to talk to Richard Smith. By keeping this connection blocked, yet allowing WinWord to talk to Microsoft Corp., the user's sensitive information remains protected while WinWord's legitimate activity remains intact.

Thus, a highly effective method for protecting non-browser apps is to display the name of the app (or a derivative of the name or an alias representing the name) along with the destination name at the time the app wants to communicate with the non-browser app. Moreover, the most secure method would be to initially block each new app/destination pair unless the pair was specifically whitelisted and/or the user chooses to unblock the communication between the pair. In addition to or alternative to displaying the app name would be to display the name of the maker of the app. For example, some embodiments might display that “Microsoft Corp.'s WinWord” wants to talk to “Microsoft Corp.”

Another highly secure method would be to temporarily block each newly encountered app/destination pair (unless the pair is whitelisted), and to display the requested connection to the user. If the user takes no action, then the app/destination pair status automatically changes to allowed. However, if the user takes action then the status changes from “temporarily blocked” to “permanently blocked” (i.e., blocked until the user specifically decides to allow it and/or the app/destination pair is later added to a whitelist).

A Trojan can literally send millions of bits of data in a single second. Therefore, the initial blocking of the Trojan is important so that not a single bit of data is compromised. On the other hand, some users may not want to have to manually allow every individual app/destination pair. By temporarily blocking all newly encountered app/destination pairs, both objectives can be satisfied for such users, and therefore, some embodiments may implement this particular method.

Showing the name to whom each app wants to talk offers convenient security for non-browser apps since the vast majority of such apps typically talk to a single company, organization, or person. In other words, the vast majority of such non-browser apps typically talk to a single Registered Owner name—usually the name of the maker of the app itself (with notable exceptions being communication with DNS Servers and/or digital certificate authorities). This property of non-browser apps lends itself to a novel form of rule-based whitelisting: if an app wants to talk to its maker and/or a DNS Server and/or a digital certificate authority, then allow it to do so. This rule is hereafter referred to as Maker-Based Whitelisting. This Maker-Based Whitelisting method elegantly protects the vast majority of non-browser apps when they are hijacked for nefarious hacking purposes.

In stark contrast to non-browser apps, the vast majority of browser traffic is to destinations other than the browser's maker. For example, the vast majority of Firefox traffic is to destinations other than Mozilla (the maker of Firefox). To complicate matters even more, when a user enters in a single URL (e.g. “cnn.com”), that webpage can connect the user to numerous other sites. For example, on Jan. 20, 2017, cnn.com automatically connected users to 56 other sites. Thus, when a Trojan hijacks a browser, the Trojan can easily hide its connection to the command and control center inside of such lists. Most users cannot decide which of the 56 seemingly random connections are legitimate and which one is a Trojan talking to a command and control node.

Therefore, with browsers, even using Registered Owner names (as opposed to domain and subdomains) does not reduce the traffic enough for the average user to spot a Trojan. The previously stated non-browser app whitelisting rule (Maker-Based Whitelisting) does not help either. Browser traffic requires a different approach.

To significantly reduce displayed browser traffic names, traffic can be managed by the following Group Policy: if the user approves a URL (or the URL is whitelisted) then allow all connections made by that URL for as long as its webpage is active in the browser, without displaying such connections. For example, if cnn.com is an allowed URL then automatically allow the 56 sites to which it connects without displaying the 56 sites.

Some embodiments of the system that can accomplish the above include (but are not limited to) a browser plugin that transmits each open URL and their connections to the security system, a local man-in-the-middle http/https interception can be used to retrieve this information, and/or a remote man-in-the-middle http/https proxy can be used to obtain open web addresses and their respective connections.

With the Group Policy, the user would see “cnn.com”—not 57 entity names (i.e., “cnn.com” plus the other 56 sites to which it connects), or even more domain/subdomains. If the user allows cnn.com, then all of cnn.com's connections can be allowed as well.

In some embodiments, a browser plugin can display the connections on the webpages themselves. For example, the main security display of the system would solely show cnn.com while the plugin could show the 56 connections on the cnn.com browser webpage itself. Such embodiments could also give the user the ability to block any and/or all of the URL's connections. Some embodiments might allow the user to see the connections from a Menu choice in the main program and/or control the individual connections from a Menu choice in the browser plugin as well.

With the Group Policy, Trojans are now easily exposed and blocked when they hijack the browser. For example, if a Trojan trying to connect to trojan.xyz.org hijacks Firefox while the user is accessing cnn.com, under the Group Policy, the user would see that Firefox wants to connect to two entities: Turner Broadcasting (the registered owner of cnn.com) and Richard Smith (the registered owner of xyz.org). The user can now easily allow the cnn.com connection while keeping the Trojan connection blocked.

The Group Policy can also be used for automation: Automatically allow open web addresses and their connections while automatically blocking everything else. In the example above, cnn.com and its connections would automatically be allowed while Trojan.xyz.org would be automatically blocked (since it is neither an open URL subdomain nor the subdomain of any connection made by an open URL).

The Group Policy easily exposes and blocks Trojans that attempt to make direct connections to their command and control center while masquerading as Firefox. However, an open loophole still remains: the Trojan can inject its command and control center destination into a webpage and thereby cause the connection to be allowed (at least temporarily).

Pages that use pure HTTPS have a degree of protection against such an attack because the HTTPS protocol uses end-to-end encryption to help prevent this very problem. However, many web pages still use HTTP which is unencrypted, and therefore, easily tricked. Also, many HTTPS man-in-the-middle proxies are in use today, which strip the HTTPS encryption protection. Thus, in neither HTTP nor HTTPS can the contents of the webpages be implicitly trusted.

To close this loophole, some embodiments can use Consensus-Based Whitelisting. In this novel method, the connections made by web addresses are recorded by one or more trusted machines (and/or a statistical deduction of the correct connections can be made from sampling a number of user machines for any given URL). When a user's computing device wants to connect to a URL, the correct connections can be retrieved from the Internet via an encrypted connection. These consensus-based connections are then used for the Group Policy (as opposed to inherently trusting the connections listed in the local webpage).

For example, if a Trojan successfully inserts trojan.xyz.org into the local cnn.com webpage (in an effort to get the security system to allow traffic to and from trojan.duckdns.org), under Consensus-Based Whitelisting, the user's computing device will download the 56 correct connections and these alone are used for the Group Policy. Thus, when Firefox seeks to connect to trojan.xyz.org, the user will see both Turner Broadcasting and Richard Smith as the two requested connections (since trojan.xyz.org was not included in the Consensus-Based Whitelisting Group Policy).

Thus, Consensus-Based Whitelisting exposes and blocks Trojans that inject themselves into browsers, regardless of whether they try to make a direct connection or whether they insert their command and control destinations into the local webpages themselves.

An alternative to or adjunct to Consensus-Based Whitelisting is the use of a web proxy for the correct identification of connections made by web addresses. (See below for a description of one embodiment.)

Consensus-Based Whitelisting can also be used for non-browser apps as an adjunct to Maker-Based Whitelisting. As one example, Consensus-Based Whitelisting can be used when an app has legitimate traffic that does not involve its maker. In other words, an app's traffic can be allowed if it passes either the Maker-Based Whitelisting rule or if one or more trusted machines (or a statistically significant number of other machines) record the same app communicating with the same destination (i.e., Consensus-Based Whitelisting).

Some embodiments can use Consensus-Based Whitelisting to automate the discovery of an apps maker.

Remote web proxies can also be used for managing open web addresses and their respective connections. For example, a remote web proxy can report the domain and/or subdomain, and/or path, and/or URL name of each open URL to the firewall. For example, if the user enters “cnn.com” in the web proxy then it can report “cnn.com” as an open URL. The web proxy could also replace connections made by open web addresses with aliases based on the web proxy's domain or some other agreed upon domain. For example, if the web proxy domain is TerraProxy.com and cnn.com connects to “optimizely.com” and “instantads.com” then the web proxy could replace “optimizely.com” with “abc.TerraProxy.com” and the web proxy could replace “instantads.com” with “xyz.TerraProxy.com”. When the local browser seeks to connect to “abc.TerraProxy.com” the web proxy converts this back to “optimizely.com” and when the local browser seeks to communicate with “xyz.TerraProxy.com” the web proxy converts this back to “instantads.com.” This will force all legitimate web browsing to flow through TerraProxy.com. Therefore, the firewall can initially block all web-based traffic that does not flow through the web proxy (e.g. TerraProxy.com). Moreover, the firewall can provide an interface for the user to see and block the list of open web addresses. The firewall reports the blocked web addresses to the web proxy, which in turn shuts down the web address and its respective connections. This will prevent Trojans from secretly using the web proxy for connectivity to a command and control center.

Some embodiments could use a plugin for certain browsers and use the remote web based proxy for other browsers. In other words, the plugin could report open web addresses and manage the connections made by those web addresses for the given browser while the remote web proxy could be used to manage open web addresses and their respective connections for browsers that do not have such plugins available.

The combination of Maker-Based Whitelisting and Consensus-Based Whitelisting (along with Group Policy) provides formidable protection for browser apps and non-browser apps alike. Therefore, a hacker could try to secretly disable the blocking/allowing security in an effort to covertly bypass it. An automated Health Monitor can protect against this remaining attack vector.

Many embodiments will implement the allowing/blocking mechanism as a kernel driver. To determine the health status of the kernel driver, the GUI process can do one or more of the following:

Periodically check the status of the driver;

Periodically poll the driver;

Receive periodic beacons from the driver; and/or

Consider the driver healthy if traffic data is regularly received from the driver.

For example, in one embodiment the GUI queries the driver every four seconds to get the information it needs to construct the display. Each time the driver responds to the query, this particular embodiment changes the color of a circle on the display (continually transitioning it from a grey color to a blue color and back again). If the driver should fail to respond to the query, then the GUI changes the color of the circle to permanent red.

In the example embodiment, if a hacker infects the GUI then the color would cease to change, and if the hacker infects the driver then the color changes to red. Such a health monitor alerts the user to both types of infection, thereby protecting the user from all attack vectors.

A number of ways are available to implement such a health monitor. Provided that the health monitor is implemented such that the GUI continually changes the presentation of the health monitor based upon continued observation of driver state within the confines of a real-time traffic monitor integrated with a real-time traffic controller, such would be in the spirit and scope of this disclosure, as would altering the presentation of the health monitor based upon a change of driver status within the same confines.

Explanation of Figures

The system and method disclosed herein control the physical network interface card (NIC) in a computer 902. The firewall component (901) can be implemented as a kernel driver; and the interface to the display (904) can be a higher-level process or program communicating with the kernel driver.

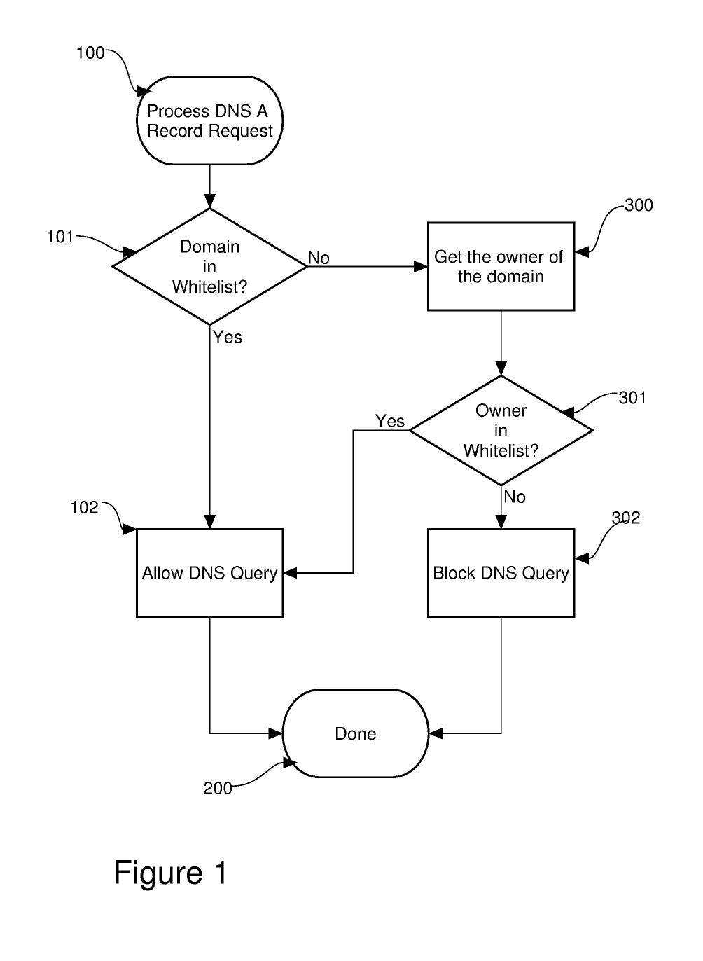

FIGS. 1-3 show one embodiment that can be a standalone Trojan trapping system and/or implemented as a subprocess, which exposes and blocks Trojans within a larger firewall system. This embodiment processes the NIC's raw data packets 100 by dividing Internet-based packets into two categories: browser packets 120 and non-browser packets 102.

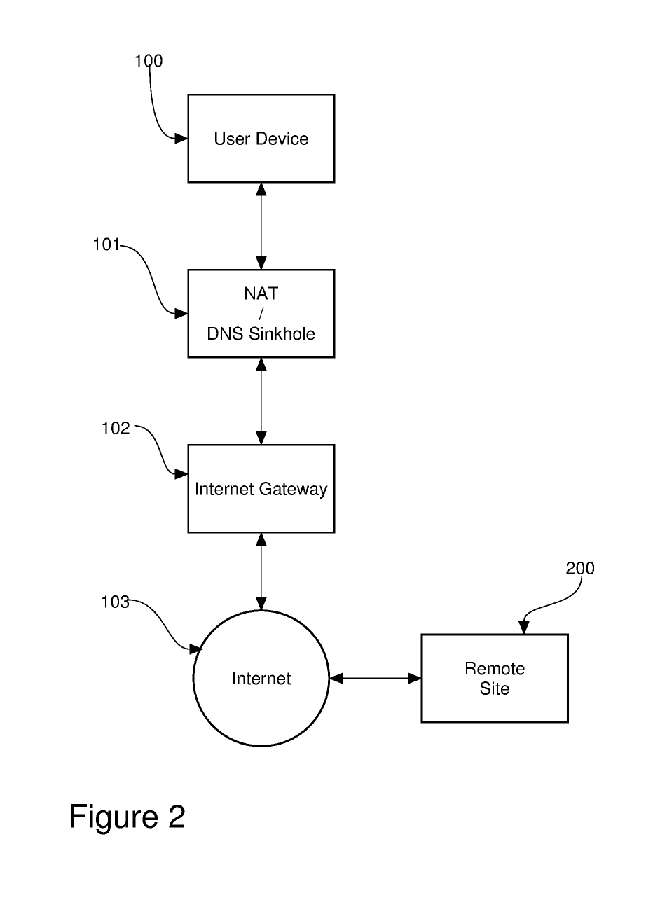

FIG. 2 shows one example embodiment for processing browser packets. This embodiment first checks to see if the packet belongs to the subdomain of an open URL 201. Alternate embodiments might check to see of the packet belongs to the domain instead (e.g., alternate embodiments might approve cnn.com even if the URL itself is the subdomain sports.cnn.com).

If the packet does belong to the subdomain of an open URL 201 then the packet is allowed 210. If the packet does not belong to the subdomain of an open URL 201 then the packet is checked to see if belongs to any of the connections made by an open URL 202.

If the packet does belong to a connection made by an open URL 202 then the packet is allowed 210. If the packet does not belong to a connection made by an open URL 202 then the packet is blocked 203.

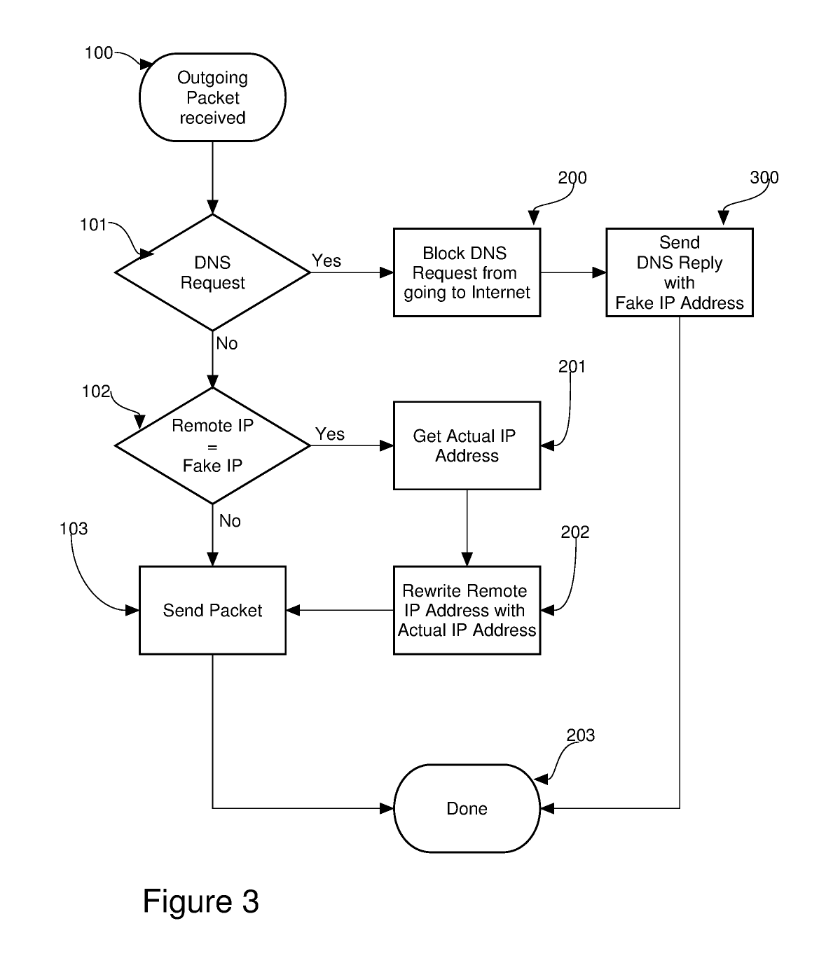

FIG. 3 shows one example embodiment for processing Internet-based packets to and from non-browser apps 300. In this particular embodiment, the name of the maker of the app is obtained 301. Most software apps these days are digitally signed. Such digital signatures contain the name of the maker of the app. This is one way of obtaining the name of the maker of the app. There are other methods well known in the art.

The next step in this example embodiment is to obtain the name of the owner of the domain of the remote device to which the app is communicating 302. Various means of obtaining this information include standard Whois lookups and/or proprietary databases (such as those published by numerous third parties).

The next step in this example embodiment is to determine whether the name of the app's maker matches the name of the domain owner 303. If the names do not match 303 then the packet is blocked 320; otherwise, the packet continues forward.

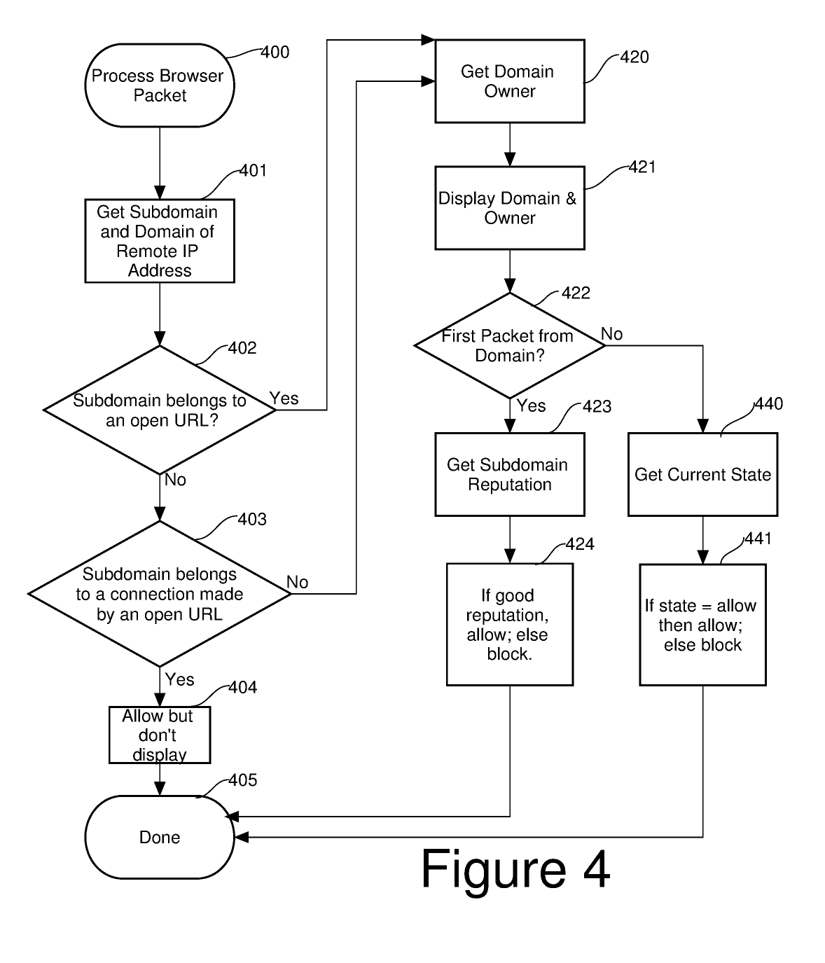

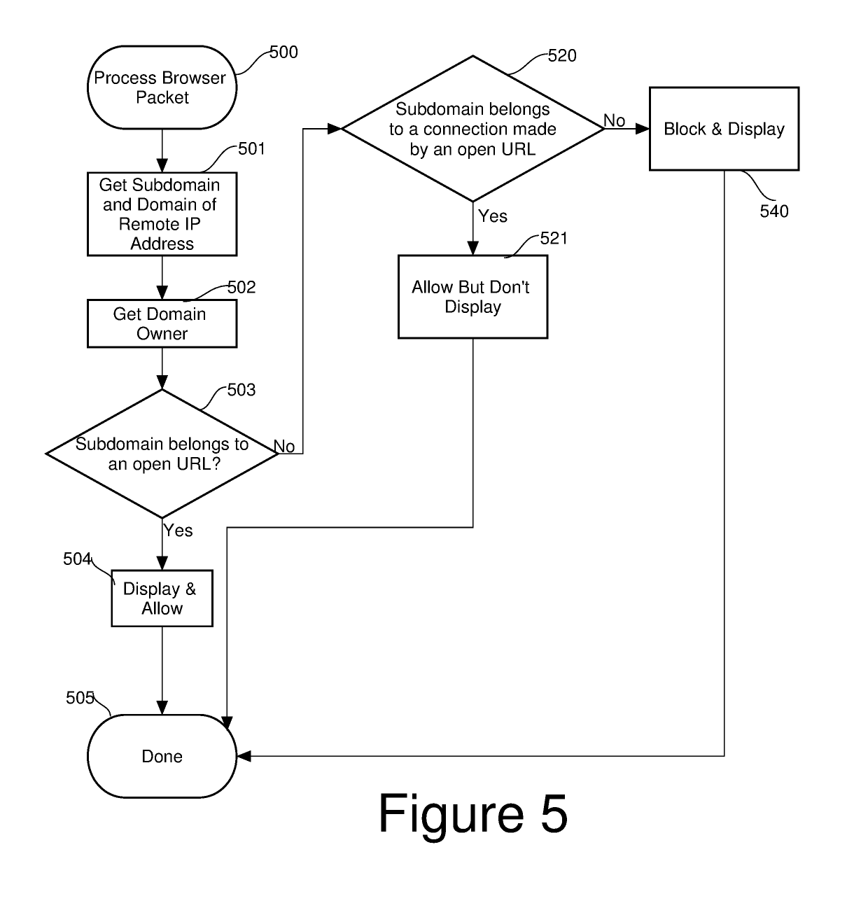

FIGS. 4 and 5 show two additional example embodiments for how browser packets can be processed. There are numerous other possible alternative embodiments. FIG. 4 is an example embodiment where the initial state is based upon the reputation of the web address. The user can then toggle the state thereafter. FIG. 5 is an embodiment that does not use a reputation engine.

In the embodiment shown in FIG. 4, browser packets 400 are processed by first translating the remote IP address into its subdomain and domain 401. For example, an IP address might be translated into subdomain maps.google.com and domain google.com. Methods for mapping IP addresses into domains/subdomains have been disclosed in U.S. Pat. No. 9,467,324. The system next checks to see if the subdomain matches an open URL 402, i.e., a web address that is open within the browser app. A browser plugin can be used to transmit open and closed web addresses. Web addresses can also be obtained from HTTP/HTTPS interception, and/or remote web proxies.

If the subdomain does not match an open URL 402, the system then checks the subdomain to see if it belongs to any of the connections made by an open URL 403, and if it does belong then it is allowed but not displayed 404. The connections made by an open web address can be determined by a browser plugin using standard Web Extensions API calls, or for greater security, the web address connections can be downloaded from a local LAN server or remote WAN server which retrieves the web address connections from one or more trusted machines that accessed the same web address and/or a statistical determination made from multiple user machines that accessed the same web address. Alternatively or adjunctively, accessing web pages via a remote web proxy can allow correct web address connections to be obtained from and/or managed by the remote web proxy.

If the subdomain does not match an open web address and it is not from any connection made by an open web address, then the domain owner name is retrieved 420. The domain owner name can be obtained by a Whois lookup and/or from proprietary database lookups (such as in cases where anonymous domain privacy services are returned in the Whois lookup). The domain name and its respective owner are displayed 421.

The packet is then checked to see if it is the first packet from the domain 422 (or alternatively from the subdomain). If it is the first packet received form the subdomain, then the subdomain's reputation is checked 423 to determine whether to allow or block it 424. If this is not the first packet from the domain/subdomain, then the current state is retrieved 440 in order to determine whether to allow or block it 441.

In the embodiment of the system shown in FIG. 5, browser packets 500 are processed by first translating the remote IP address into its subdomain and domain 501. Then, the owner is retrieved 502. If the subdomain matches an open URL 503 then the owner and domain (and/or subdomain) are displayed and allowed 504.

If the subdomain does not match an open URL 503 then the system of this embodiment checks to see if the subdomain belongs to a connection made by an open URL 520. The same methods discussed above can be used to determine connections made by open web addresses. If the subdomain belongs to a connection made by an open URL 520 then it is allowed but not displayed 521; otherwise, the subdomain is blocked and displayed 540.

FIGS. 4 and 5 both illustrate examples of embodiments of the system in which the connections made by open web addresses can be allowed yet not displayed in order for Trojans that hijack browsers to easily be exposed and blocked. Any Trojan hijacking a browser will be displayed in these embodiments. Meanwhile, the plethora of extraneous web address connections will not be displayed so that the Trojan's presence is readily seen by the user and blocked.

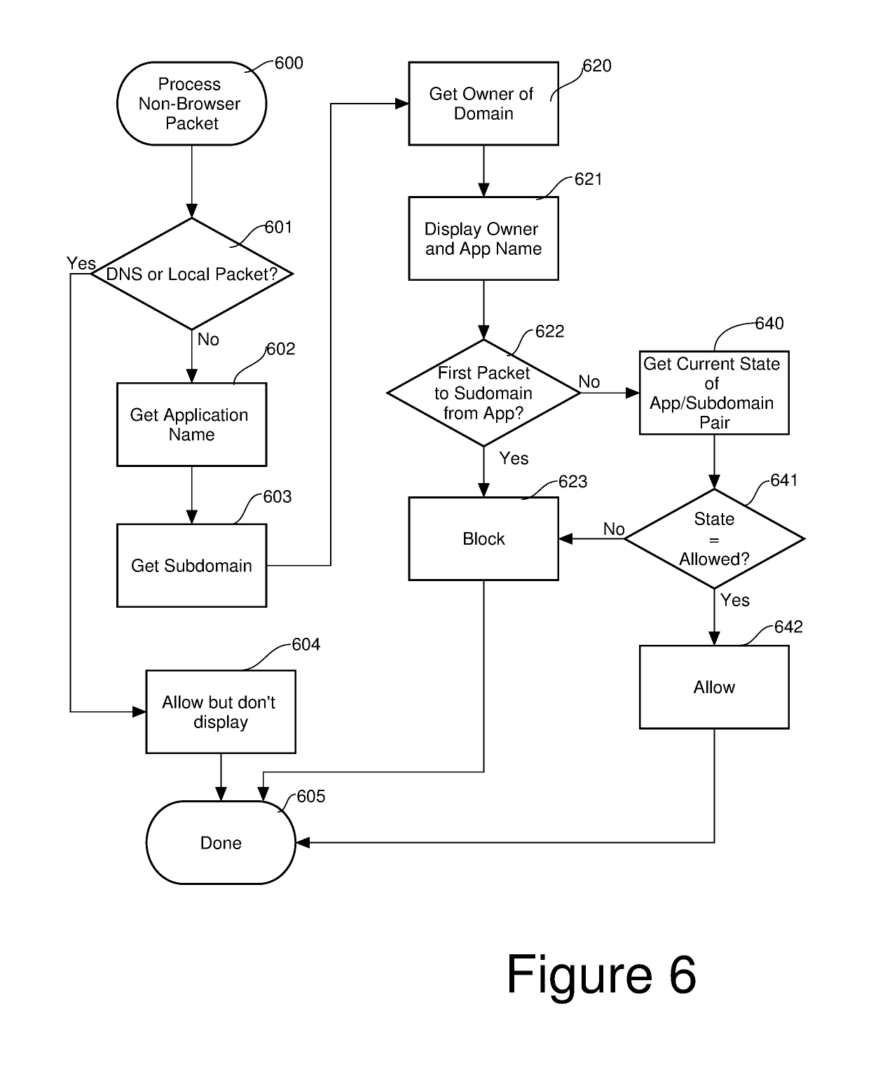

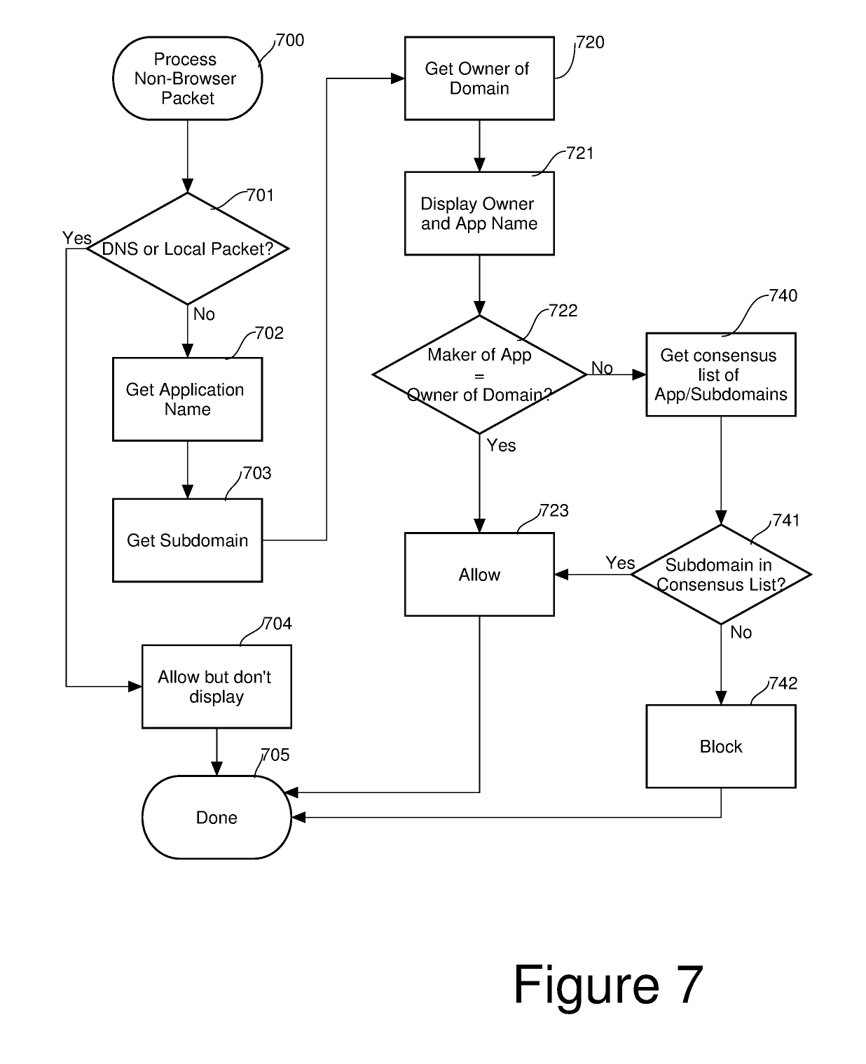

FIGS. 6 and 7 illustrate additional example embodiments for processing non-browser data packets, i.e., data packets sent to and from a non-browser app. Numerous alternative embodiments are possible. The FIG. 6 embodiment illustrates a manual implementation in which every new app/destination pair is initially blocked. The user can then manually toggle the status thereafter. The FIG. 7 embodiment illustrates an automated implementation that uses a combination of Maker-Based Whitelisting and Consensus-Based Whitelisting to determine the initial state of each app/destination pair. The user can then toggle the status thereafter, if the user so chooses.

The FIG. 6 embodiment begins by first examining whether the packet is either a DNS packet or local packet 601. If it is either of these types of data packets, then the packet is allowed but not displayed 604. Alternatively, the DNS packets can be processed in accordance with the methods disclosed in U.S. Pat. No. 9,467,324 for greater security.

If the packet is neither a DNS packet nor a local packet 601 then the name of the application with which it is communicating is retrieved 602. Modern operating systems provide Transport Layer API calls to obtain such information. Next, the IP address of the remote machine is translated into a subdomain 603. Next, the owner of the subdomain is retrieved 620. The app and its owner are then displayed 621.

If this is the first packet from the app/destination pair 622 then the initial status is set to blocked 623. If this is not the first packet from the app/destination pair 622 then the current state is retrieved 640 in case the user previously has manually allowed the pair. If the current state is not allowed 641 then the pair remains blocked 623. If the current state is allowed 641 then the pair remains allowed 642. Note that the manual toggling of states is described in U.S. Pat. No. 9,467,324, which is incorporated herein in its entirety by this reference.

The FIG. 7 embodiment is the same as the FIG. 6 embodiment until the App/Owner Name are displayed 721. Then, at this point, this embodiment uses Consensus-Based whitelisting to determine initial status.

The FIG. 7 embodiment checks to see if the maker of the app matches the domain owner 722. If it does, then the packet is initially allowed 723. If the maker of the app does not match the domain owner 722 then a consensus list of app/destination pairs is retrieved from a local LAN server and/or a remote WAN server 740. If the destination is in the consensus list 741 then the pair is initially allowed 723; otherwise, the pair is initially blocked 742.

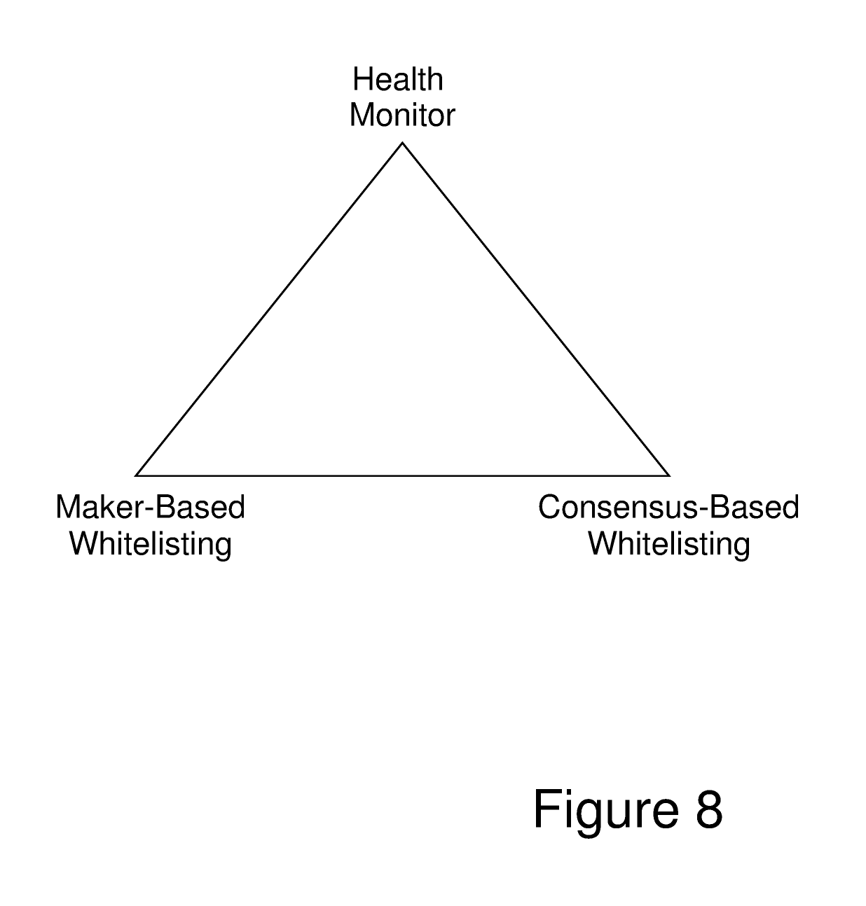

FIG. 8 illustrates an embodiment implementing the tri-level security of Automated Health Monitor, Maker-Based Whitelisting, and Consensus-Based Whitelisting. As long as the Health Monitor is transitioning in color (e.g., grey→blue→grey→repeat), the Maker-Based Whitelisting and Consensus-Based Whitelisting can be trusted. Otherwise, the user is alerted to disconnect from the Internet to keep the computing device contents safe. Any continually changing characteristic (e.g., color, shape, etc.) can be used in the Health Monitor to signify ongoing security.

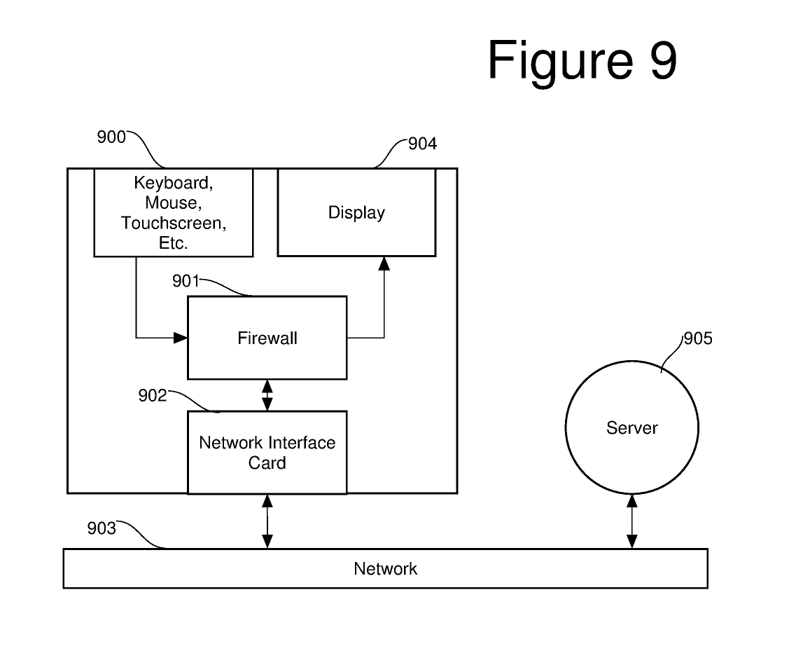

FIG. 9 illustrates the system and method's control of the physical components of a computing device. The user keyboard, mouse, touchscreen, etc., 900 are used to toggle state changes (see U.S. Pat. No. 9,467,324 for alternative embodiment implementations). The firewall itself 901 blocks/allows the data packets of the NIC 902 in accordance with the disclosure contained herein as well as the disclosure contained in U.S. Pat. No. 9,467,324. The server 905 houses the connections made by various web addresses to be retrieved and used for Consensus-Based Whitelisting. The server can also house app/destination pairs for embodiments that use Consensus-Based Whitelisting for non-browser apps.

The invention provides systems, devices, and methods for blocking DNS tunnels, which are often used by hackers to send and receive data from a computing device using Trojans and other malware.

As discussed above, novel systems and methods that incorporate the following are disclosed:

a. A process for solely allowing browsers to communicate with legitimate sites.

b. A process for solely allowing non-browser apps to communicate with legitimate sites.

In embodiments with one or more such processes (whether they be the same processes disclosed herein or other processes with the same outcome), DNS tunneling can be completely disabled. In such embodiments:
When a DNS IP address query is made, return a fake IP address.
When a packet destined for the fake IP address arrives, generate a legitimate DNS query to find the real IP address.
Replace the fake IP address in the packets with the real IP address.

Although elegant, this method fully accomplishes the presumed “not possible” outcome of fully stopping DNS tunnels. How so? Notice that this method only performs the actual DNS IP address resolution after a packet has already been approved by the browser and/or non-browser app security processes. Hence, DNS IP address resolutions only occur for legitimate traffic.

Consider the following example. The browser wants to talk to apple.com. Therefore, the browser sends a DNS request for the IP address of apple.com. A fake IP address is sent so that no errors occur in the browser (i.e., so the browser believes it has received an IP address, and thereby concludes the domain is resolvable). Meanwhile, the user is alerted that the browser wants to talk to apple.com. No packets addressed to apple.com can leave the computer until the user chooses so.

Once the user chooses to allow apple.com, one or more packets destined to apple.com (with the fake IP address) will be generated. These packets are intercepted, and a real DNS query is generated to find the real IP address of apple.com. Then, the fake IP address is rewritten with a real IP address. The browser can freely communicate with apple.com, unaware of the security mechanism underneath.

How does this stop DNS tunneling? Let's say that malware tells the browser to connect to John-Smith-1234-56-789.iamahacker.com (in order to exfiltrate John Smith's social security number). The browser generates a DNS request for John-Smith-1234-56-789.iamahacker.com; and a fake IP address is sent instead. In other words, the hacker's DNS name server has not received the DNS request, and therefore, remains oblivious to John Smith's social security number. Provided that John Smith does not choose to allow traffic to iamahacker.com, John's information remains safe—without a single byte of information being transferred to the hacker via DNS tunneling.

So far, two embodiments have been disclosed:

(1) Send one or more DNS queries to a Sinkhole, which replies with one or more fake IP addresses; and

(2) When the user's computer transmits a packet to a fake IP address, a network address translator (NAT) queries a genuine DNS server for the real IP address, and swaps the fake IP address with a real IP address.

Thus, all DNS queries are processed, yet no domain-to-IP resolution occurs until the computer sends its first communication packet. Since all DNS queries instantly receive a reply, the apps and browsers do not break. But since the actual IP address resolution only occurs after the first communication, all DNS tunnels are fully blocked.

How does this block DNS tunnels? Let's say that a DNS query is made for JohnSmith-123456789.iamahacker.com (see example above). The following sequence of events occurs:

(a) A DNS query for JohnSmith-123456789.iamahacker.com is made to the Sinkhole which automatically sends back a fake address (i.e., no actual domain-to-IP resolution has been attempted).

(b) Since iamahacker.com does not match any entry in the Domain Records nor the Owner Records, no communication packet will ever be sent to it (since such communication is blocked by the dynamically-generated whitelisting disclosed herein).

(c) Therefore, no domain-to-IP resolution will ever occur for JohnSmith-123456789.iamahacker.com, keeping the user's name and social security number safely out of the hacker's hands.

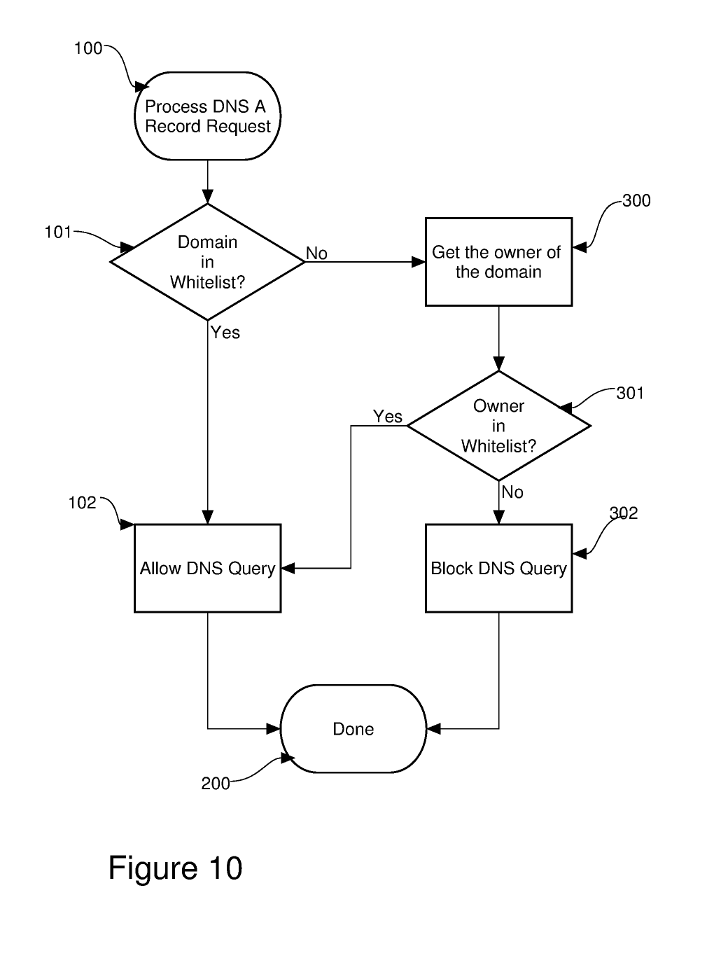

It bears noting that the NAT can be on the local machine and/or be on a separate device positioned between the user's computer and the Internet and/or be on a device located in or connected to the world-wide web. The NAT can obtain the fake IP address and its corresponding domain by listening to the DNS request/reply and/or the security system can send to the NAT the fake IP address and/or the corresponding domain name. FIG. 10 shows one example embodiment architecture with an external NAT situated between the user and the Internet gateway.

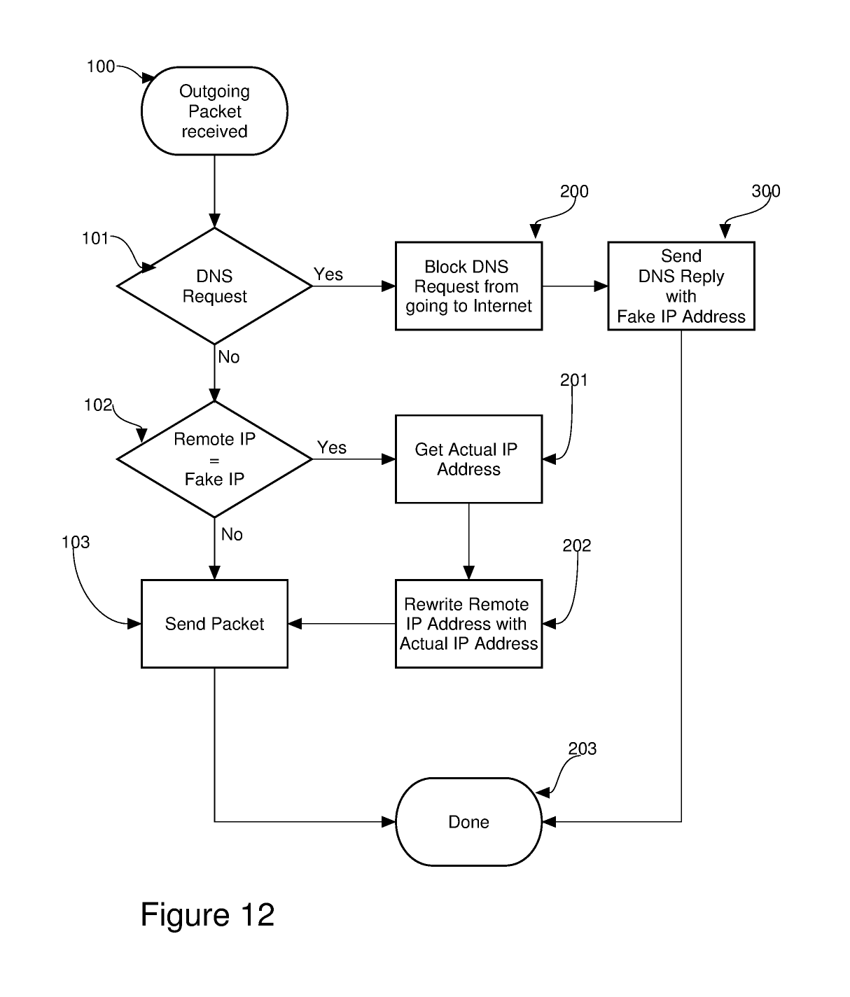

It further bears noting that the DNS Sinkhole can be a process running on the local machine and/or a separate device on the local network and/or a separate device accessible on the world-wide web. FIG. 12 shows one exemplary embodiment of architecture with the DNS Sinkhole accessible via the world-wide web.

Some embodiments can include a hybrid approach, merging the benefits of both of the above embodiments. For example, the second approach can be used for website access; while the first approach can be used for all the sites from which the webpage pulls content.

Consider the example above when a user's browser wants to open apple.com. Just as above, a fake IP address is given until the user chooses to allow apple.com. Then, the real IP address is resolved. However, for all of the sites from which apple.com pulls content, all of these sites are automatically whitelisted (via dynamically generated whitelisting), and therefore, the IP addresses of all of these sites are automatically resolved with genuine DNS responses with genuine IP addresses.

Consider webpages such as cnn.com and foxnews.com which often pull content from literally hundreds of sites. Once the user allows either of these webpages, all the rest of the security automatically flows from there, including the DNS Tunnel Security. Thus, such hybrid embodiments maintain the benefits of both approaches:

One benefit of these systems and methods is that the apps work seamlessly since they always immediately receive an IP address (whether the IP address is genuine or fake). Another benefit of these systems and methods is that the user does not need to interactively approve all of the sites that a browser wants to access since the content sites will be dynamically whitelisted based upon the approval of the webpage itself.

FIG. 10 illustrates one embodiment in which DNS queries are resolved based upon a whitelist. For example, allowed webpages are supplied, and then, other allowed domains are dynamically generated based upon this allowance. It bears noting that the whitelist of webpages can be interactive, it could be from static, it could be based on real-time behavioral analysis, etc. Any manner of whitelist generation is within the spirit and scope of this disclosure.

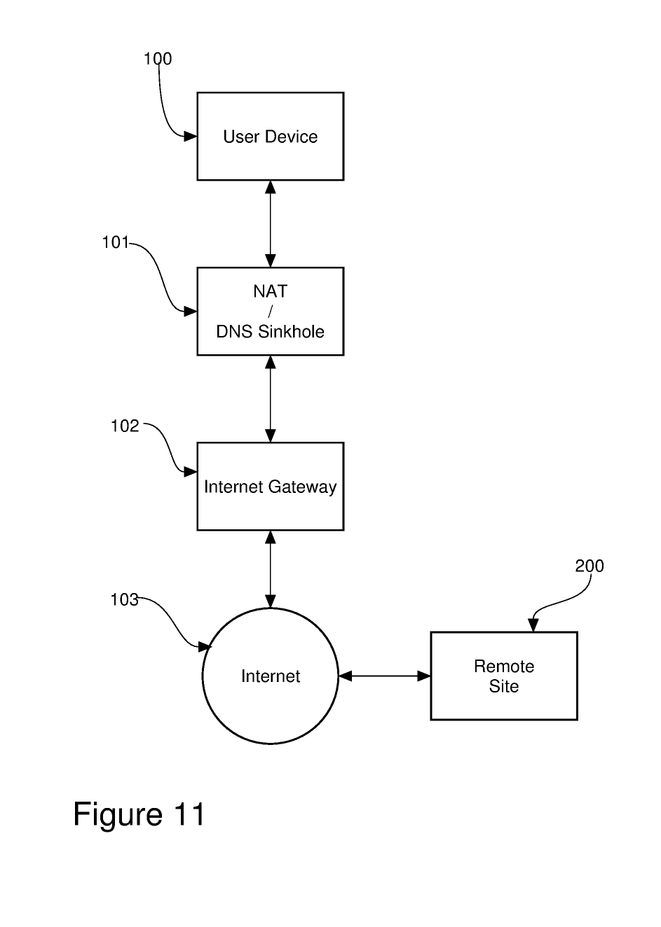

FIGS. 11-12 illustrate one embodiment in which DNS queries are solely resolved after a packet is destined for a previously received fake IP address.

Some embodiments can be hybrids that incorporate the features illustrated in FIGS. 10-12. This includes, but is not limited to, web browser software applications. The domain entered into the address bar can be handled with delayed DNS resolution (as illustrated in FIGS. 11-12), whereas the sites from which the page pulls content can be dynamically added to a whitelist, thereby allowing their DNS resolution to occur in conformity with FIG. 10.

FIG. 10 illustrates a whitelist-based DNS tunnel blocking embodiment. A DNS A Record request is received 100. (DNS A Records are requests for IPv4 address of a domain. It should be noted that the exact same process be applied to DNS AAAA requests which are requests for the IPv6 address of a domain.) If the DNS request is in the whitelist 101 then the DNS request is allowed 102, and the process is done 200.

If the DNS request is not in the whitelist 101, then the system obtains the owner (i.e., owner name or other owner-identifying information) of the domain 300. If the domain owner is whitelisted 301, then the system allows the DNS query 102 and exits the process 200. If the domain owner is not in the whitelist 301, then the system blocks the DNS query 302 and exits the process 200.

FIG. 11 shows an exemplary embodiment in which a local device 102 (such as a router) houses both the NAT and DNS Sinkhole processes. It is important to note that subprocesses are processes. In other words, if an embodiment implements NAT and DNS Sinkhole capabilities as subprocesses of a larger process, both the NAT and DNS Sinkhole subprocesses are still “processes” in their own right.

Communication from the user device 100 passes through the local device 102 on its way to and from the Internet Gateway 102. The DNS Sinkhole is responsible for sending a fake IP address for at least one DNS request, whereas the NAT is responsible for replacing the fake remote IP address of at least one packet with the actual remote IP address.

Some embodiments can implement that NAT process on the user's device and/or on a separate local device and/or on a remote device accessible via the world-wide web. Likewise, some embodiments can implement the DNS Sinkhole process on the user's device and/or on a separate local device and/or on a remote device accessible via the world-wide web.

FIG. 12 illustrates one embodiment, which implements both the NAT and DNS Sinkhole processes. An outgoing packet is received 100. (It bears noting that the NAT can also transform the actual IP address into the fake IP address for incoming packets, even though this is not illustrated for simplicity's sake).

If the packet is a DNS request 101, then the DNS request is blocked from going out to the Internet 200. A DNS reply with a fake IP address is sent to the process that made the DNS request 300, and then, the process exits 203.

If the packet is not a DNS request 101, then the destination IP address is examined 102. If the destination IP address is a previously returned fake IP address 102, then the actual IP address is obtained 103. (If this is the first packet destined to the domain, then the actual IP address is obtained by sending a DNS request to a DNS server; if this not the first packet, then the address previously received from the DNS request from the first packet can be used.) The packet's destination IP address is rewritten with the actual IP address 202, and this rewritten packet is sent 103. Then, the process exits 203.

If the packet is not a DNS request 101, and the packet's remote destination is not a fake IP address 102, then the packet is sent unchanged 103. Then, the process exits 203.

The embodiments represented by the figures are illustrative only. Therefore, it should be noted that there are a number of various ways to implement the processes disclosed herein to produce the system and method disclosed herein. Any process, system, or method for restricting domain-to-IP resolution for one or more DNS queries based on the owner of the domain contained within that DNS query is within the spirit and scope of this disclosure. Likewise, any process, system, or method for restricting domain-to-IP resolution for one or more DNS queries based on the domain contained within that DNS query due to that domain being allowed or blocked via a dynamically-generated whitelisting method is within the spirit and scope of this disclosure. Likewise, any process, system, or method of delaying actual IP address resolution to after a communication is attempted to the domain is within the spirit and scope of this disclosure.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for blocking DNS tunnels, the system comprising:
a computing device comprising a processor and an associated memory, wherein the computing device is communicatively connected to a communications network;
a software application being operable on the computing device;
a dynamically-generated whitelist;
a process for intercepting at least one DNS query resulting from at least one attempt by the browser software application to connect to at least one domain; and
a process for blocking the at least one DNS query, wherein the at least one DNS query is for a domain name that is not permitted by the whitelist.

2. The system of claim 1, wherein the software application comprises a browser software application.

3. The system of claim 1, wherein the software application comprises a non-browser software application.

4. A system for blocking DNS tunnels, the system comprising:
a computing device comprising a processor and an associated memory, wherein the computing device is communicatively connected to a communications network;
a software application being operable on the computing device;
a process for intercepting at least one DNS query resulting from at least one attempt by the browser software application to connect to at least one domain;
a process for returning a fake IP address in response to the at least one DNS query;
a process for intercepting at least one data communication packet;
a process to identify whether a remote IP address is a previous fake IP address previously provided by the system in response to a previous DNS query;
a process for finding the actual remote IP address for the at least one data communication packet destined for the fake IP address; and
a process for replacing the fake IP address with the actual IP address in the at least one data communication packet.

5. The system of claim 4, wherein the software application comprises a browser software application.

6. The system of claim 4, wherein the software application comprises a non-browser software application.

7. A method for blocking DNS tunnels, the method comprising the steps of:
(a) providing a system comprising:
(i) a computing device comprising a processor and an associated memory, wherein the computing device is communicatively connected to a communications network;
(ii) a software application being operable on the computing device; and
(iii) a dynamically-generated whitelist;
(b) intercepting at least one DNS query resulting from at least one attempt by the software application to connect to at least one domain; and
(c) blocking the at least one DNS query, wherein the at least one DNS query is for a domain name that is not permitted by the whitelist.

8. The method of claim 7, wherein the software application comprises a browser software application.

9. The method of claim 7, wherein the software application comprises a non-browser software application.

10. A method for blocking DNS tunnels, the method comprising the steps of:
(a) providing a system comprising:
(i) a computing device comprising a processor and an associated memory, wherein the computing device is communicatively connected to a communications network; and
(ii) a software application being operable on the computing device;
(b) intercepting at least one DNS query resulting from at least one attempt by the software application to connect to at least one domain;
(c) returning a fake IP address in response to the at least one DNS query;
(d) intercepting at least one data communication packet;
(e) identifying whether a remote IP address is a previous fake IP address previously provided by the system in response to a previous DNS query;
(f) finding the actual remote IP address for the at least one data communication packet destined for the fake IP address; and
(g) replacing the fake IP address with the actual IP address in the at least one data communication packet.

11. The method of claim 10, wherein the software application comprises a browser software application.

12. The method of claim 10, wherein the software application comprises a non-browser software application.
